(19) United States
(12) Patent Application Publication
(10) Pub. No.: US 2008/0014913 A1
(43) Pub. Date: Jan. 17, 2008

(54) Cellular mobile modbus data collection

(75) Inventor: Jason George Balan, Red Deer (CA)

Correspondence Address: Jason Balan, 7 4676 61 Street, Red Deer, AB, T4N 2R2, CA

(73) Assignee: Jason George Balan, Red Deer (CA)

(21) Appl. No.: 11/825,963

(22) Filed: Jul. 11, 2007

Related U.S. Application Data
(60) Provisional application No. 60/819,917, filed on Jul. 12, 2006.

(30) Foreign Application Priority Data
Jul. 12, 2006 (CA) 60819917

(51) Int. Cl. H04M 3/42

(52) U.S. Cl. 455/418

(57) ABSTRACT

Cellular Mobile Modbus Data Collection. Application on a cellular mobile device that collects and transfers data from field devices to server.

Application on mobile device transfers data from field devices to server.

The application is installed on a Bluetooth or similar protocol enabled cellular phone.

The application is first configured to securely connect to a Bluetooth/RS232 or RS485 converter. This converter is connected to the field device (Remote terminal unit or Programmable Logic Controller).

The application is then configured to collect specific data points from the field device. Once these configurations are set they are then saved in the mobile device.

The mobile device when within range of the field device connects via Bluetooth or similar protocol automatically.

The mobile device then collects the data via Modbus ASCII or RTU over Bluetooth or similar protocol, stores the data on the mobile device and when within cellular coverage sends the data to a server automatically.

If there is an alarm personnel will be notified automatically via the mobile device so that action can be taken.

### DESCRIPTION OF DRAWINGS

The accompanying drawing illustrates certain non-limiting example embodiments of the disclosure.

FIG. 1 illustrates a schematic overview of one non-limiting example embodiment of a Bluetooth enabled device.

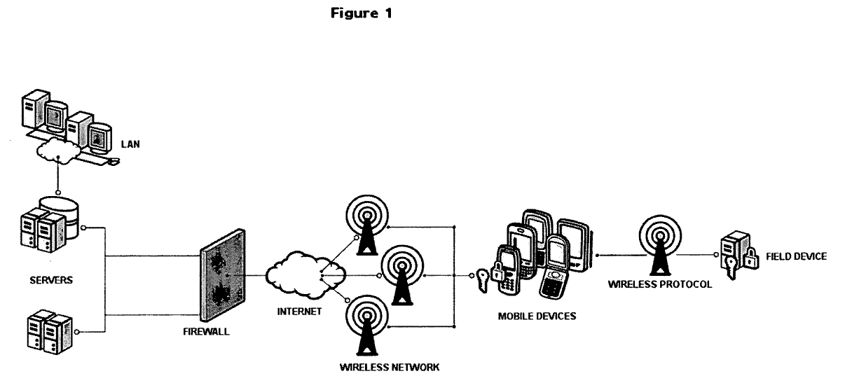

The Mobile Devices connects to the Field Devices via wireless protocol.

The Mobile Devices then send data retrieved from Field Devices over the Wireless Network/Internet to the Servers to be viewed via the Lan.

1. Application on mobile device that collects data from a field device and transmits it to server.

2. The method of claim 1 where the mobile device is cellular based.

3. The method of claim 1 where the mobile device is a handheld unit.

4. The method of claim 1 where the mobile device has Bluetooth or similar protocol.

5. The method of claim 1 the application is installed on the mobile device.

6. The method of claim 1 the application uses Modbus ASCII or RTU over Bluetooth or similar protocol.

7. The method of claim 1 the field device communicates via Bluetooth or similar protocol

8. The method of claim 1 the communication between mobile device and field device is secure.

9. The method of claim 1 the mobile and field device have preset usernames and password.

10. The method of claim 1 the application is configurable to store field device registers to communicate with field device.

11. The method of claim 1 the application is configurable to store alarm set points.

12. The method of claim 1 the application will notify personal of alarms via predefined settings.

13. The method of claim 1 the application will store data on mobile device.

14. The method of claim 1 the application will send data via cellular network or similar network to central server.

15. The method of claim 1 the application will remove data off mobile device once data has been sent to server.
